(19) United States
(12) Patent Application Publication
(10) Pub. No.: US 2006/0092810 A1
(43) Pub. Date: May 4, 2006

(54) Optical disk device and data recording device therefor

(75) Inventor: Yuichi Sakamoto, Tokyo (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: TEAC Corporation

(21) Appl. No.: 11/261,838

(22) Filed: Oct. 27, 2005

(30) Foreign Application Priority Data
Oct. 29, 2004 (JP) 2004-316069

(51) Int. Cl. G11B 7/20

(52) U.S. Cl. 369/94; 369/47.1

(57) ABSTRACT

An optical disk device records data on an optical disk in which a recording layer which is at an upper position with respect to a side from which a light beam is irradiated, and a recording layer which is at a lower position, are formed in multiple layers. After replay data is recorded in a data zone of the upper recording layer and in a data zone of the lower recording layer, standard data is recorded in a middle zone of the lower recording layer from a radially outer position of the disk to a radially inner position of the disk. After recording in the middle zone of the lower recording layer, standard data is recorded in the middle zone of the upper recording layer from a radially inner position of the disk to a radially outer position of the disk.

### BACKGROUND OF THE INVENTION

1. Field of the Invention

The present invention relates to an optical disk device and a data recording device therefor, and in particular, to an optical disk device and a data recording device which record data on an optical disk having a plurality of recording layers formed in multiple layers.

2. Description of the Related Art

Recently, optical disks such as a CD and a DVD have become widespread. A multiple-layer optical disk has been proposed in which a plurality of recording layers are formed in multiple layers in order to improve a recording capacity of the optical disk. An optical disk device for recording data in each recording layer of the multiple-layer optical disk has also been proposed (refer to, for example, Japanese Patent Laid-Open Publication No. 2002-237050).

A structure of a double-layer optical disk will now be described referring to FIG. 2 as an example of a multiple-layer optical disk. In a double-layer optical disk, as shown in FIG. 2, a recording layer L0 which is at an upper side with respect to the side from which laser light is irradiated, and a recording layer L1 which is at a lower side, are formed in layers with a spacer layer therebetween. The upper recording layer L0 has a data zone DZ0 in which replay data is recorded, a middle zone MZ0 which is closer to an outer periphery of the disk than is the data zone DZ0 and in which data according to a standard is recorded, and an outer drive area ODA0 which is closer to the outer periphery of the disk than is the middle zone MZ0. Similarly, the lower recording layer L1 has a data zone DZ1 in which replay data is recorded, a middle zone MZ1 which is closer to the outer periphery of the disk than is the data zone DZ1 and in which data according to a standard is recorded, and an outer drive area ODA1 which is closer to the outer periphery of the disk than is the middle zone MZ1. The structure of each of the recording layers L0 and L1 is defined by a standard.

When data is to be recorded in the data zones DZ0 and DZ1 and the middle zones MZ0 and MZ1 of the double-layer optical disk, in general, the data is recorded through the following method. First, as shown in FIG. 3A, the replay data is recorded in the data zone DZ0 of the upper recording layer L0 from a radially inner position of the disk toward a radially outer position of the disk. Then, as shown in FIG. 3B, replay data is recorded in the data zone DZ1 of the lower recording layer L1 from a radially outer position of the disk toward a radially inner position of the disk. Next, as shown in FIG. 9A, data is recorded in the middle zone MZ0 of the upper recording layer L0 from a radially inner position of the disk toward a radially outer position of the disk. Then, as shown in FIG. 9B, data is recorded in the middle zone MZ1 of the lower recording layer L1 from a radially outer position of the disk toward a radially inner position of the disk.

In the above-described data recording method, however, when the data is recorded in the middle zone, the data recording process is easily affected by a difference in the reflectance in a boundary between a recorded region and an unrecorded region of the other recording layer. For example, when the data is to be recorded in the middle zone MZ0 of the upper recording layer L0, the recording process tends to be affected by the difference in reflectance at a boundary between a recorded region and an unrecorded region on the lower recording layer L1. When the data is to be recorded on the middle zone MZ0, a track servo control is applied so that the irradiation position of the laser light on the optical disk (position of light spot) is not off-track, but off-track tends to occur because of the difference in the reflectance. In addition, even when the starting position of recording in the middle zone MZ0 is a position which avoids the boundary between the recorded region and the unrecorded region on the lower recording layer L1, the light spot may travel over the boundary between the recorded region and the unrecorded region on the lower recording layer L1 when the data recording of the middle zone MZ0 is started due to, for example, decentering difference of the recording layers or the like. Because of this, it is difficult to stably record data in the middle zone MZ0.

In the art of Japanese Patent Laid-Open Publication No. 2002-237050, a boundary portion between the recorded region and the unrecorded region is determined in a plurality of recording layers when data is to be recorded on a multiple-layer optical disk in which the plurality of recording layers are formed in layers, and during a recording process to one recording layer, the data is not recorded to a region in which the degree of influence by the boundary portion in the other recording layer to the tracking servo process is large. In this related art reference, however, the data is recorded simply by avoiding the region in which the influence by the boundary between the recorded region and the unrecorded region is large, and therefore, it is difficult to effectively use that region of the optical disk.

### SUMMARY OF THE INVENTION

The present invention advantageously provides an optical disk device and a data recording device therefor in which data can be stably recorded in a middle zone of an optical disk in which a plurality of recording layers are formed in multiple layers.

According to the present invention, there is provided a data recording device for an optical disk device wherein data is recorded on an optical disk in which a recording layer which is at an upper position with respect to a side from which a light beam is irradiated and a recording layer which is at a lower position are formed in layers. Each recording layer comprises a data zone in which replay data is recorded and a middle zone which is closer to an outer periphery of the disk than is the data zone and in which standard data is recorded. The data recording device according to the present invention comprises a recording controller which controls the irradiation position of a light beam on the optical disk when data is recorded to control the recording position of data on the optical disk. The recording controller executes a lower side middle zone recording operation in which standard data is recorded in the middle zone of the lower recording layer from a radially outer position of the disk toward a radially inner position of the disk after the replay data is recorded in the data zone of the upper recording layer and the data zone of the lower recording layer. After the lower side middle zone recording operation is executed, the recording controller executes an upper side middle zone recording operation in which standard data is recorded in the middle zone of the upper recording layer from a radially inner position of the disk toward a radially outer position of the disk.

According to another aspect of the present invention, after the replay data is recorded in the data zone of the upper recording layer and the data zone of the lower recording layer, the recording controller executes an upper side middle zone recording operation in which standard data is recorded in the middle zone of the upper recording layer from a radially inner position of the disk toward a radially outer position of the disk. After the upper side middle zone recording operation is executed, the recording controller then executes a lower side middle zone recording operation in which standard data is recorded in the middle zone of the lower recording layer from a radially outer position of the disk toward a radially inner position of the disk. During execution of the upper side middle zone recording operation, the recording controller records the data to a position which is radially further out than a position from which the recording to the middle zone of the lower recording layer is expected to start.

The optical disk device according to the present invention records data by irradiating a light beam from an optical pickup device onto an optical disk in which a recording layer which is at an upper position with respect to a side from which the light beam is irradiated, and a recording layer which is at a lower position, are formed in layers. According to another aspect of the present invention, the optical disk device comprises the data recording device according to the present invention.

According to the present invention, it is possible to prevent the occurrence of off-track due to a difference in reflectance in a boundary between a recorded region and an unrecorded region when data is recorded to a middle zone of an optical disk in which a plurality of recording layers are formed in multiple layers.

### BRIEF DESCRIPTION OF THE DRAWINGS

A preferred embodiment of the present invention will be described in detail with reference to the drawings, wherein:

FIG. 1 is a block diagram schematically showing a structure of an optical disk device having a data recording device according to a preferred embodiment of the present invention;

FIG. 2 is a diagram exemplifying a double-layer optical disk;

FIG. 3A is a diagram for explaining an operation of recording data in a data zone;

FIG. 3B is a diagram for explaining an operation of recording data in a data zone;

FIG. 4 is a flowchart for explaining an operation of recording data in a middle zone according to a preferred embodiment of the present invention;

FIG. 5A is a diagram for explaining an operation of recording data in a middle zone according to a preferred embodiment of the present invention;

FIG. 5B is a diagram for explaining an operation of recording data in a middle zone according to a preferred embodiment of the present invention;

FIG. 6A is a diagram for explaining an operation of recording data in a middle zone according to a preferred embodiment of the present invention;

FIG. 6B is a diagram for explaining an operation of recording data in a middle zone according to a preferred embodiment of the present invention;

FIG. 7A is a diagram for explaining another operation of recording data in a middle zone according to a preferred embodiment of the present invention;

FIG. 7B is a diagram for explaining another operation of recording data in a middle zone according to a preferred embodiment of the present invention;

FIG. 8A is a diagram for explaining another operation of recording data in a middle zone according to a preferred embodiment of the present invention;

FIG. 8B is a diagram for explaining another operation of recording data in a middle zone according to a preferred embodiment of the present invention;

FIG. 9A is a diagram for explaining an operation of recording data in a middle zone according to related art; and

FIG. 9B is a diagram for explaining an operation of recording data in a middle zone according to related art.

### DESCRIPTION OF THE PREFERRED EMBODIMENT

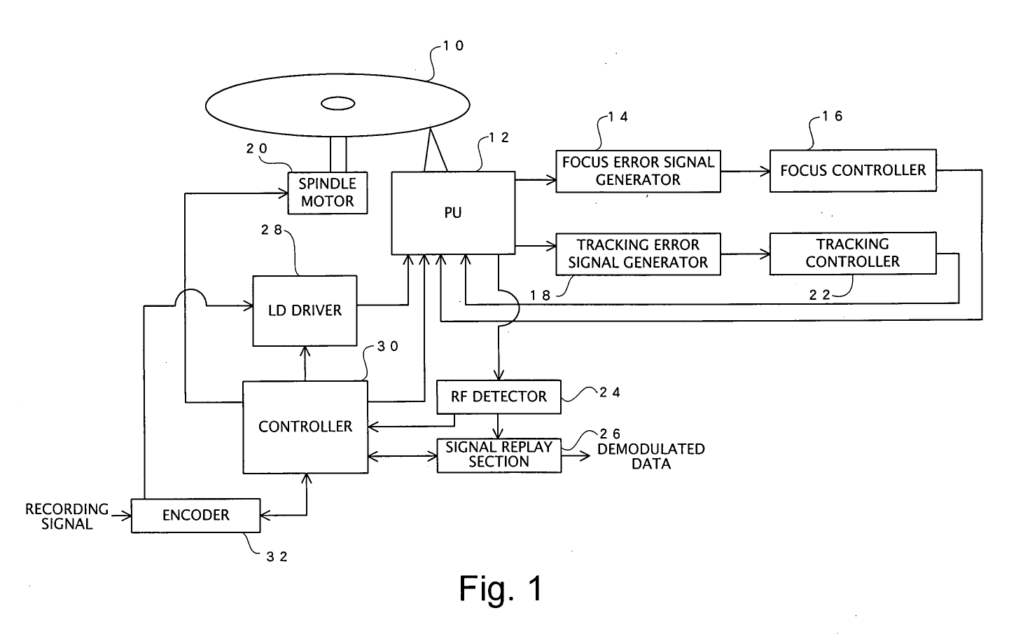

A preferred embodiment of the present invention will now be described. FIG. 1 is a block diagram schematically showing a structure of an optical disk device having a data recording device according to a preferred embodiment of the present invention. A recordable optical disk 10 such as DVD+R is rotationally driven by a spindle motor 20. An optical pickup device (PU) 12 is placed opposing the optical disk 10 and comprises a laser diode (LD) for irradiating laser light to the optical disk 10 as a light beam and a photodetector which detects light reflected from the optical disk 10 and converts the detected light into an electrical signal.

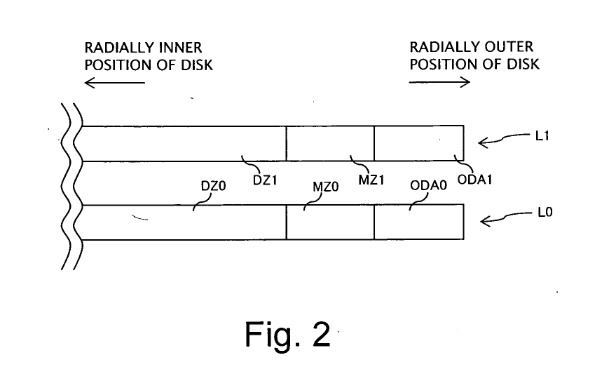

As shown in FIG. 2, the optical disk 10 is a double-layer optical disk in which a recording layer L0 which is at an upper position with respect to a side from which the laser light is irradiated and a recording layer L1 which is at a lower position with respect to the side from which the laser light is irradiated are formed in multiple layers with a spacer layer therebetween. The upper recording layer L0 comprises a data zone DZ0 in which replay data is recorded, a middle zone MZ0 which is closer to an outer periphery of the disk than is the data zone DZ0 and in which data according to a standard is recorded, and an outer driver area ODA0 which is closer to the outer periphery of the disk than is the middle zone MZ0. Similarly, the lower recording layer L1 comprises a data zone DZ1 in which replay data is recorded, a middle zone MZ1 which is closer to the outer periphery of the disk than is the data zone DZ1 and in which data according to a standard is recorded, and an outer drive area ODA1 which is closer to the outer periphery of the disk than is the middle zone MZ1.

Although not shown, each of the middle zones MZ0 and MZ1 comprises a buffer zone, a reserved zone, and a guard zone from a radially inner position of the disk toward the periphery. The outer drive area ODA0 comprises an outer disk administration zone, an outer disk count zone, a dummy zone, an outer disk test zone, and a guard zone, in that order from a radially inner position of the disk toward the periphery. The outer drive area ODA1 comprises an outer disk administration zone, an outer disk count zone, a count zone run-in, an outer disk test zone, and a guard zone, in that order from a radially inner position of the disk toward the periphery. The outer drive areas ODA0 and ODA1 are optional areas in which data may or may not be recorded.

Although not shown in FIG. 2, a lead-in zone and an inner drive area are provided in that order from the data zone DZ0 of the upper recording layer L0 toward a position which is radially further in than the data zone DZ0. A lead-out zone and an inner drive area are provided in that order from the data zone DZ1 of the lower recording layer L1 toward a position which is radially further in than the data zone DZ1. The specific structures of the recording layers L0 and L1 are defined by a standard.

A focus error signal generator 14 generates a focus error signal based on reflected light (electrical signal) detected by the photodetector within the optical pickup device 12 and outputs the focus error signal. A focus controller 16 applies a focus servo control by applying a control to drive the optical pickup device 12 in a focus direction based on the focus error signal from the focus error signal generator 14.

A tracking error signal generator 18 generates a tracking error signal based on reflected light (electrical signal) detected by the photodetector in the optical pickup device 12 and outputs the tracking error signal. Here, the tracking error signal can be generated, for example, using a push-pull method. A tracking controller 22 drives the optical pickup device 12 along a radial direction of the optical disk 10 (track direction) to minimize a level of the tracking error signal from the tracking error signal generator 18 to control a position of the light spot in the radial direction of the optical disk 10. With this process, the track servo control is applied so that the position of the light spot does not become off-track.

An RF detector 24 amplifies an electrical signal detected in the photodetector of the optical pickup device 12 to generate a replay RF signal, applies a filtering process and an equalizing process, and outputs the resulting signal to a signal replay section 26. The signal replay section 26 AC-couples an input signal from the RF detector 24, binarizes the AC-coupled signal using a threshold voltage, and demodulates the binarized signal to output demodulated data.

The RF detector 24 also extracts an address signal which is address data of the optical disk 10 included in the replay RF signal and supplies the extracted address signal to a controller 30. An encoder 32 modulates (encodes) the input recorded signal and outputs the modulated signal to an LD driver 28. The LD driver 28 drives the laser diode in the optical pickup device 12 so that laser light having the power modulated by the modulated signal is irradiated. In this manner, data is recorded on the optical disk 10.

The controller 30 is constructed by a micro-computer and controls operations of the elements of the optical disk device. For example, the controller 30 controls the emission power of the laser diode in the optical pickup device 12 by controlling the drive process of the LD driver 28. The emission power of the laser light by the laser diode is suitably set corresponding to a case in which data is recorded onto the optical disk 10 and to a case in which data is read from the optical disk 10. The controller 30 further drives and controls the optical pickup device 12 and the spindle motor 20 during recording or replaying of data to or from the optical disk 10, to control a position of irradiation of laser light (position of light spot) on the optical disk 10. With this process, the position of recording or replaying of data on the optical disk 10 is controlled.

Next, a recording operation in an optical disk device according to a preferred embodiment of the present invention, in particular, an operation for recording data in the data zones DZ0 and DZ1 and the middle zones MZ0 and MZ1 of the optical disk 10 by a controller 30 based on a recording signal, will be described.

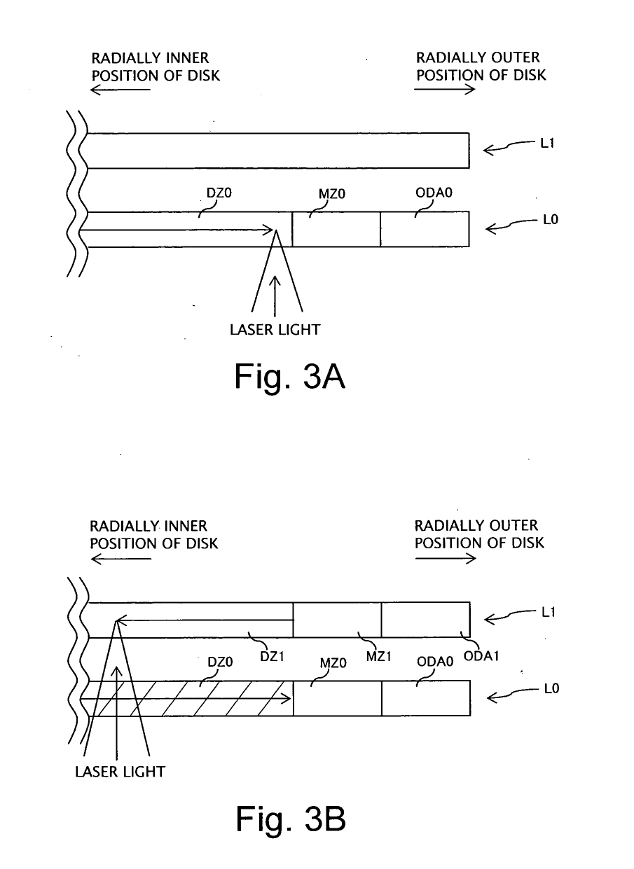

First, as shown in FIG. 3A, an upper side data zone recording operation is executed in which replay data is recorded in the data zone DZ0 of the upper recording layer L0 from a radially inner position of the disk toward a radially outer position of the disk. Then, after the upper side data zone recording operation is executed, as shown in FIG. 3B, a lower side data zone recording operation is executed in which replay data is recorded in the data zone DZ1 of the lower recording layer L1 from a radially outer position of the disk toward a radially inner position of the disk.

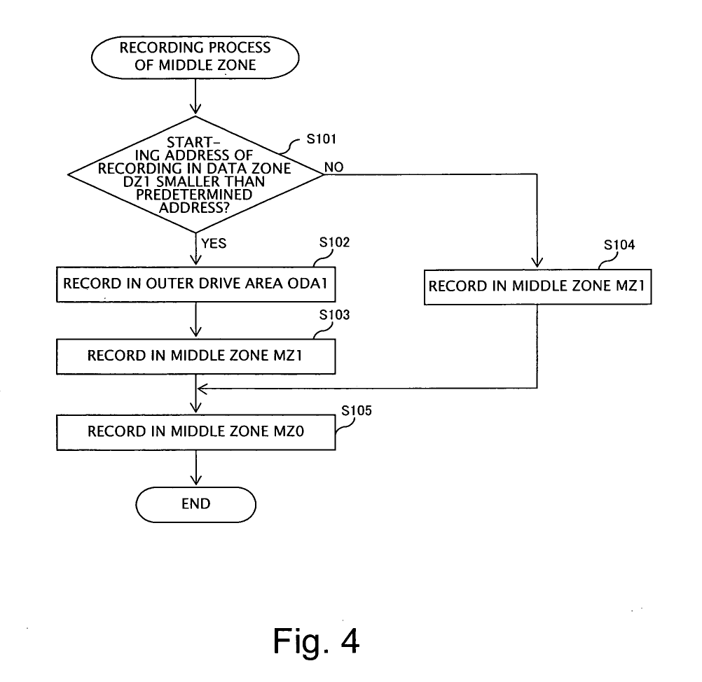

After the replay data is recorded in the data zone DZ0 of the upper recording layer L0 and in the data zone DZ1 of the lower recording layer L1, an operation to record data in the middle zones MZ0 and MZ1 is executed according to a flowchart shown in FIG. 4.

In step S101, it is determined whether or not the address of start of recording (outermost address) of the data zone DZ1 of the lower recording layer L1 is smaller than a predetermined address. The address of the upper recording layer L0 is counted in an increasing manner toward a radially outer position of the disk and the address of the lower recording layer L1 is counted in an increasing manner toward a radially inner position of the disk. The predetermined address in this process is an address which is set based on the outermost address (smallest address) of the middle zone MZ1. When the address of start of recording of the data zone DZ1 is smaller than the predetermined address, that is, when the outermost position of the data zone DZ1 is at a position which is radially further out than a predetermined position (position determined based on the outermost position of the middle zone MZ1), the process proceeds to step S102. When, on the other hand, the address of start of recording of the data zone DZ1 is the predetermined address or greater, that is, when the outermost position of the data zone DZ1 is not at a position which is radially further out than the predetermined position, the process proceeds to step S104.

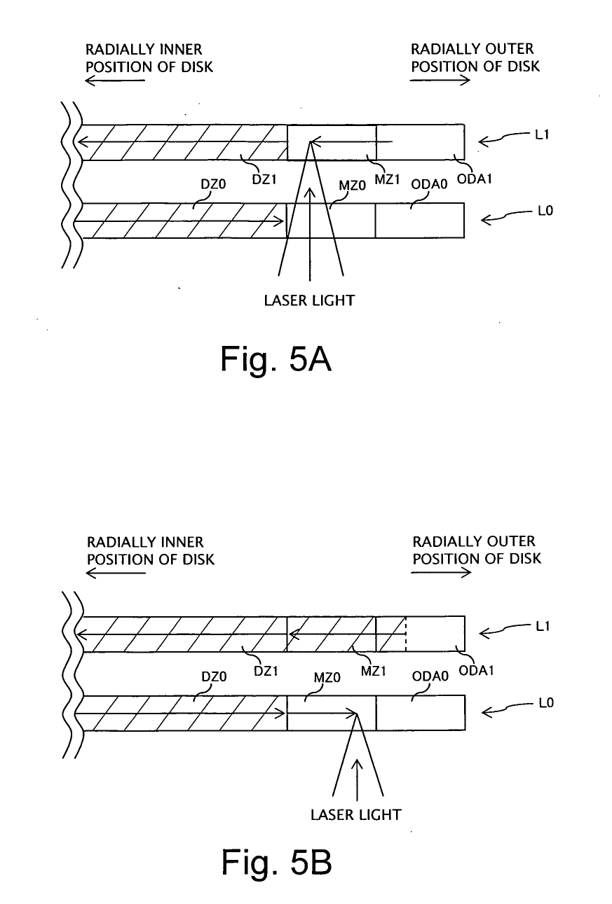

In steps S102 and S103, as shown in FIG. 5A, a lower side middle zone recording operation is executed in which standard data is recorded in the middle zone MZ1 of the lower recording layer L1 from a radially outer position of the disk toward a radially inner position of the disk. During execution of the lower side middle zone recording operation, however, the recording process of data is started at a position which is radially further out than a position in which the data recording of the middle zone MZ0 of the upper recording layer L0 is expected to be completed, in order to avoid influences by a boundary between a recorded region and an unrecorded region of the lower recording layer L1 when data is recorded to the middle zone MZ0 of the upper recording layer L0. Therefore, when the outermost position of the data zone DZ1 is at a position which is radially further out than a predetermined position (when the determination result in step S101 is YES), the recording process of the data is started from a region closer to the outer periphery of the disk than the middle zone MZ1 of the lower recording layer L1, and after predetermined data is recorded in this region, the standard data is recorded in the middle zone MZ1. In the example structure of the optical disk 10 shown in FIG. 2, because the region which is closer to the outer periphery of the disk than is the middle zone MZ1 is the outer drive area ODA1, after predetermined data is recorded in a portion of the outer driver area ODA1 (for example, approximately 1000 h sectors) (step S102), standard data is recorded in the middle zone MZ1 (step S103). More specifically, in step S102, the predetermined data is recorded in (for example, approximately 1000 h sectors in) the outer disk administration zone which is the innermost zone in the outer drive area ODA1. The predetermined data to be recorded may be arbitrarily set. After the lower side middle zone recording operation is executed, the process proceeds to step S105.

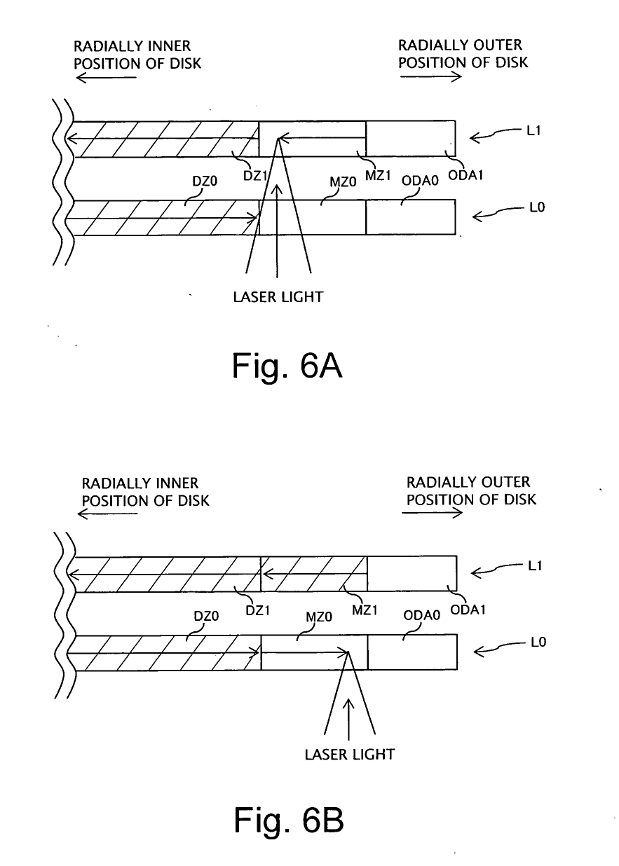

When, on the other hand, the outermost position of the data zone DZ1 is not at a position radially further out than the predetermined position of the disk (when the determination result in step S101 is NO), the recording process of the data can be started at a position of the disk sufficiently far out in the radial direction from the position of the middle zone MZ0 of the upper recording layer L0 in which the data recording process is expected to be completed even when the recording process of the data is started in the middle zone MZ1. Therefore, in the lower side middle zone recording operation of step S104, as shown in FIG. 6A, no data is recorded in the outer drive area ODA1 and the standard data is recorded in the middle zone MZ1 from a radially outer position of the disk toward a radially inner position of the disk. More specifically, it is configured so that the data is recorded in the guard zone which is the outermost zone in the middle zone MZ1 with a length which is longer by, for example, approximately 1000 h sectors. In other words, the recording process is started from a position which is approximately 1000 h sectors further out in the radial direction. After the execution of the lower side middle zone recording operation, the process proceeds to step S105.

In step S105, as shown in FIG. 5B or 6B, an upper side middle zone recording operation is executed in which standard data is recorded in the middle zone MZ0 of the upper recording layer L0 from a radially inner position of the disk toward a radially outer position of the disk. During this process, the recording process of the data is completed at a position on the disk which is radially further in than the region of the lower recording layer L1 in which data is already recorded. Then, the operations for recording data in the middle zones MZ0 and MZ1 are completed.

As described, in the present embodiment, the data is recorded in the middle zone MZ0 of the upper recording layer L0 after data is recorded in the middle zone MZ1 of the lower recording layer L1. During the recording process in the middle zone MZ1, the data recording process is started at a position which is radially further out than the position of the middle zone MZ0 in which the recording of the data is expected to be completed. Because of this configuration, the recording process in the middle zone MZ0 of the upper recording layer L0 is not affected by the difference in the reflectance in a boundary between a recorded region and an unrecorded region of the lower recording layer L1. Thus, occurrence of off-track due to the difference in reflectance in the boundary between the recorded region and the unrecorded region can be prevented and data can be stably recorded in the middle zone MZ0. Such a recording operation is particularly effective for an optical pickup device 12 which tends to be affected by the difference in the reflectance in the boundary between the recorded region and the unrecorded region of the lower recording layer L1 during the recording process on the upper recording layer L0.

Another example configuration of the present embodiment will now be described. In the present embodiment, data may be recorded in the middle zones MZ0 and MZ1 through the following operation.

After the replay data is recorded in the data zone DZ0 of the upper recording layer L0 and in the data zone DZ1 of the lower recording layer L1, an upper side middle zone recording operation is executed in which standard data is recorded in the middle zone MZ0 of the upper recording layer L0 from a radially inner position of the disk toward a radially outer position of the disk. During execution of the upper side middle zone recording operation, the data is recorded to a position which is radially further out than a position in which the data recording process in the middle zone MZ1 of the lower recording layer L1 is expected to start, in order to avoid the influence of a boundary between a recorded region and an unrecorded region of the upper recording layer L0 during the data recording process in the middle zone MZ1 of the lower recording layer L1.

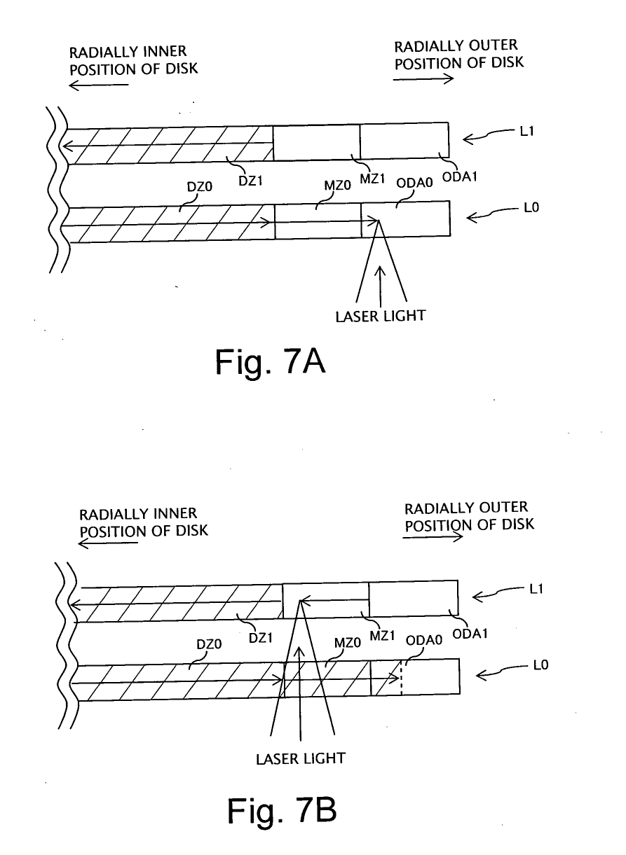

When the recording completion address of the data zone DZ0 of the upper recording layer L0 is greater than a predetermined address, that is, when the outermost position of the data zone DZ0 is radially further out than a predetermined position, as shown in FIG. 7A, predetermined data is recorded in a region which is closer to the outer periphery of the disk than is the middle zone MZ0 after standard data is recorded in the middle zone MZ0 of the upper recording layer L0. In the example optical disk 10 shown in FIG. 2, because the region which is closer to the outer periphery of the disk than is the middle zone MZ0 is the outer drive area ODA0, predetermined data is recorded in a portion (for example, approximately 1000 h sectors) of the outer drive area ODA0 after the standard data is recorded in the middle zone MZ0.

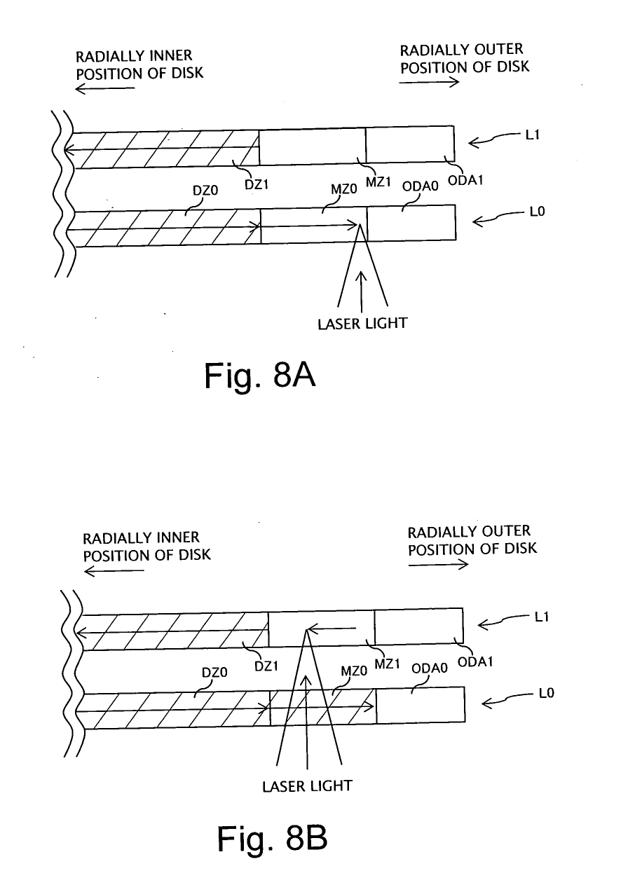

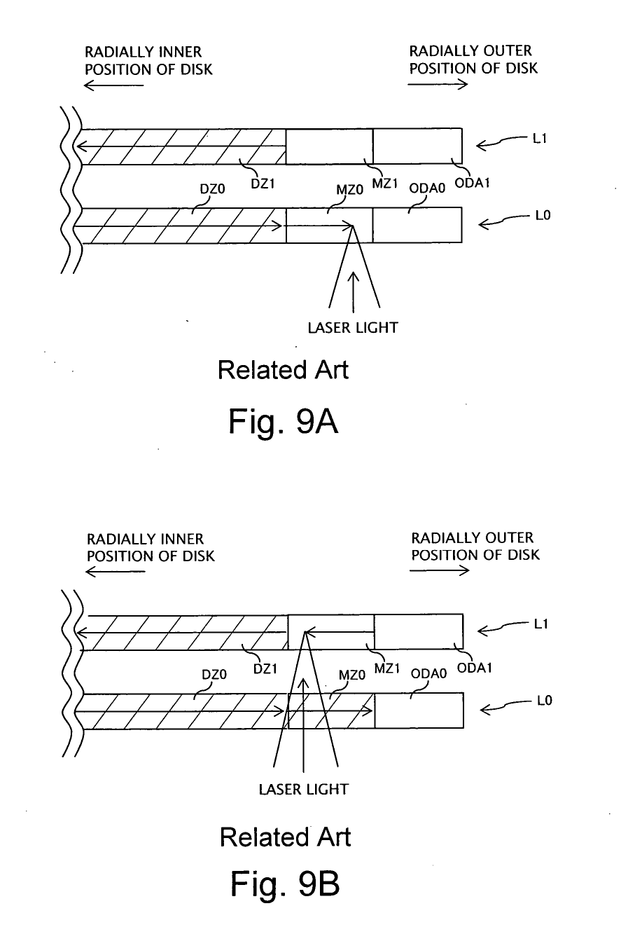

When, on the other hand, the recording completion address in the data zone DZ0 is less than or equal to the predetermined address, that is, when the outermost position of the data zone DZ0 is not at a position which is radially further out than the predetermined position, data can be recorded to a position on the disk which is radially further out than the position in the middle zone MZ1 of the lower recording layer L1 in which the data recording process is expected to start, without continuing the recording process of data to the outer drive area ODA0. In this case, as shown in FIG. 8A, no data is recorded in the outer drive area ODA0 and the standard data is recorded in the middle zone MZ0 from a radially inner position of the disk to a radially outer position of the disk. More specifically, the controller 30 is configured such that the data is recorded, for example, by an amount of approximately 1000 h sectors longer, to the guard zone which is the outermost zone in the middle zone MZ0. In other words, the recording process is continued to a radially outer position by approximately 1000 h sectors outward.

After the upper side middle zone recording operation is executed, as shown in FIG. 7B or 8B, a lower side middle zone recording operation is executed in which standard data is recorded in the middle zone MZ1 of the lower recording layer L1 from a radially outer position of the disk to a radially inner position of the disk. During this operation, the data recording process is started at a position of the disk which is further in than the region of the upper recording layer L0 in which data is already recorded. Then, the operations to record data in the middle zones MZ0 and MZ1 are completed.

In this configuration, because the data recording process in the upper recording layer L0 is continued to a position which is radially further out than the position in the middle zone MZ1 in which the data recording process is expected to start, the recording process of the middle zone MZ1 of the lower recording layer L1 is not affected by the difference in reflectance in the boundary between the recorded region and the unrecorded region in the upper recording layer L0. Therefore, the occurrence of off-track due to the difference in reflectance in the boundary between the recorded region and the unrecorded region can be prevented and data can be stably recorded in the middle zone MZ1. Such a recording operation is particularly effective for an optical pickup device 12 having a characteristic in which the recording process in the lower recording layer L1 tends to be affected by the difference in the reflectance in the boundary between the recorded region and the unrecorded region of the upper recording layer L0.

Other preferable forms of the present invention include, for example, a program which causes a computer to function as means for executing the operations of recording to the data zones DZ0 and DZ1 and the middle zones MZ0 and MZ1, and a computer readable storage medium which store the program such as, for example, various storage media including a CD-ROM, a DVD-ROM, and a flexible disk. By installing these programs in the computer and executing the program, the advantages of the present invention can be obtained.

A preferred embodiment of the present invention has been described. The present invention, however, is not limited to the preferred embedment and various modifications can be made without departing from the scope of the present invention.

What is claimed is:

1. A data recording device of an optical disk device which records data on an optical disk in which a recording layer which is at an upper position with respect to a side from which a light beam is irradiated, and a recording layer which is at a lower position, are formed in multiple layers, each of the upper recording layer and the lower recording layer having a data zone in which replay data is to be recorded and a middle zone which is closer to an outer periphery of the disk than is the data zone and in which standard data is to be recorded, wherein
the data recording device comprises a recording controller which controls an irradiation position of a light beam on an optical disk during recording of data to control a position on the optical disk in which the data is recorded; and
the recording controller executes a lower side middle zone recording operation in which standard data is recorded in the middle zone of the lower recording layer from a radially outer position of the disk to a radially inner position of the disk after replay data is recorded in the data zone of the upper recording layer and in the data zone of the lower recording layer, and executes an upper side middle zone recording operation in which standard data is recorded in the middle zone of the upper recording layer from a radially inner position of the disk to a radially outer position of the disk after the lower side middle zone recording operation is executed.

2. A data recording device according to claim 1, wherein
during the execution of the lower side middle zone recording operation, the recording controller starts recording of data from a position on the disk which is radially further out than a position at which recording in the middle zone of the upper recording layer is expected to be completed.

3. A data recording device according to claim 2, wherein
during the execution of the lower side middle zone recording operation, the recording controller records the standard data in the middle zone of the lower recording layer after the recording controller records predetermined data in a region which is closer to the outer periphery of the disk than is the middle zone of the lower recording layer.

4. A data recording device according to claim 3, wherein
the recording controller records the predetermined data in the region which is closer to the outer periphery of the disk than is the middle zone of the lower recording layer during the execution of the lower side middle zone recording operation when an outermost position of the data zone of the lower recording layer is at a position of the disk which is radially further out than a predetermined position.

5. A data recording device according to claim 3, wherein
the region which is closer to the outer periphery of the disk than is the middle zone of the lower recording layer is an outer drive area.

6. A data recording device of an optical disk device which records data on an optical disk in which a recording layer which is at an upper position with respect to a side from which a light beam is irradiated and a recording layer which is at a lower position are formed in multiple layers, each of the upper recording layer and the lower recording layer having a data zone in which replay data is to be recorded and a middle zone which is closer to an outer periphery of the disk than is the data zone and in which standard data is to be recorded, wherein
the data recording device comprises a recording controller which controls an irradiation position of a light beam on an optical disk during recording of data to control a position on the optical disk in which the data is recorded;
the recording controller executes an upper side middle zone recording operation in which standard data is recorded in the middle zone of the upper recording layer from a radially inner position of the disk to a radially outer position of the disk after replay data is recorded in the data zone of the upper recording layer and in the data zone of the lower recording layer, and executes a lower side middle zone recording operation in which standard data is recorded in the middle zone of the lower recording layer from a radially outer position of the disk to a radially inner position of the disk after the upper side middle zone recording operation is executed, and
during execution of the upper side middle zone recording operation, the recording controller records data to a position on the disk which is radially further out than a position at which recording in the middle zone of the lower recording layer is expected to start.

7. A data recording device according to claim 6, wherein
during execution of the upper side middle zone recording operation, the recording controller records predetermined data in a region which is closer to the outer periphery of the disk than is the middle zone of the upper recording layer after the recording controller records the standard data in the middle zone of the upper recording layer.

8. A data recording device according to claim 7, wherein
the recording controller records the predetermined data in the region which is closer to the outer periphery of the disk than is the middle zone of the upper recording layer during the execution of the upper side middle zone recording operation when an outermost position of the data zone of the upper recording layer is at a position of the disk which is radially further out than a predetermined position.

9. A data recording device according to claim 7, wherein
the region which is closer to the outer periphery of the disk than is the middle zone of the upper recording layer is an outer drive area.

10. An optical disk device which records data, by irradiating a light beam from an optical pickup device, on an optical disk in which a recording layer which is at an upper position with respect to a side from which the light beam is irradiated, and a recording layer which is at a lower position, are formed in multiple layers, each of the upper recording layer and the lower recording layer having a data zone in which replay data is to be recorded and a middle zone which is closer to an outer periphery of the disk than is the data zone and in which standard data is to be recorded, wherein
the optical disk device comprises a recording controller which controls an irradiation position of a light beam on an optical disk during recording of data to control a position on the optical disk in which data is recorded; and
the recording controller executes a lower side middle zone recording operation in which standard data is recorded in the middle zone of the lower recording layer from a radially outer position of the disk to a radially inner position of the disk after replay data is recorded in the data zone of the upper recording layer and in the data zone of the lower recording layer, and executes an upper side middle zone recording operation in which standard data is recorded in the middle zone of the upper recording layer from a radially inner position of the disk to a radially outer position of the disk after the lower side middle zone recording operation is executed.

11. An optical disk device which records data, by irradiating a light beam from an optical pickup device, on an optical disk in which a recording layer which is at an upper position with respect to a side from which the light beam is irradiated and a recording layer which is at a lower position are formed in multiple layers, each of the upper recording layer and the lower recording layer having a data zone in which replay data is to be recorded and a middle zone which is closer to an outer periphery of the disk than is the data zone and in which standard data is to be recorded, wherein
the optical disk device comprises a recording controller which controls an irradiation position of a light beam on an optical disk during recording of data to control a position on the optical disk in which the data is recorded;
the recording controller executes an upper side middle zone recording operation in which standard data is recorded in the middle zone of the upper recording layer from a radially inner position of the disk to a radially outer position of the disk after replay data is recorded in the data zone of the upper recording layer and in the data zone of the lower recording layer, and executes a lower side middle zone recording operation in which standard data is recorded in the middle zone of the lower recording layer from a radially outer position of the disk to a radially inner position of the disk after the upper side middle zone recording operation is executed, and
during execution of the upper side middle zone recording operation, the recording controller records data to a position on the disk which is radially further out than a position at which recording in the middle zone of the lower recording layer is expected to start.
